(19) United States
(12) Patent Application Publication
(10) Pub. No.: US 2022/0398607 A1
(43) Pub. Date: Dec. 15, 2022

(54) METHOD FOR INVERSE REINFORCEMENT LEARNING AND INFORMATION PROCESSING APPARATUS

(71) Applicant: FUJITSU LIMITED, Kawasaki-shi (JP)

(72) Inventor: Katsumi Homma, Kawasaki (JP)

(73) Assignee: FUJITSU LIMITED, Kawasaki-shi (JP)

(21) Appl. No.: 17/694,512

(22) Filed: Mar. 14, 2022

(30) Foreign Application Priority Data
Jun. 14, 2021 (JP) 2021-098783

(51) Int. Cl. G06Q 30/02; G06N 20/20

(52) U.S. Cl. CPC G06Q 30/0201; G06N 20/20

(57) ABSTRACT

A non-transitory computer-readable recording medium having stored therein a program includes: an instruction for obtaining movement paths included in a plurality of customers that have purchased a first commodity; an instruction for modifying first one or more parameters of a reward function to second one or more parameters, the reward function including a state of a plurality of positions respectively associated with a plurality of commodities including the first commodity, by inverse reinforcement learning based on the movement paths of the customers under a state where a first parameter related to a first position associated with the first commodity of the reward function is fixed; and an instruction for outputting information representing a relationship between the first commodity and a second commodity based on a second parameter related to a second position associated with the second commodity, the second parameter being included in the second one or more parameters.

### CROSS-REFERENCE TO RELATED APPLICATION

This application is based upon and claims the benefit of priority of the prior Japanese Patent application No. 2021-098783, filed on Jun. 14, 2021, the entire contents of which are incorporated herein by reference.

### FIELD

The embodiment discussed herein is related to a method for inverse reinforcement learning, and an information processing apparatus.

### BACKGROUND

In the analysis of the purchase behavior of a customer, it is known to analyze a purchase correlation of commodities purchased by the customer. The purchase correlation may mean, for example, the relationship of purchases between commodities, e.g., co-occurrence relationship, coincidence relationship, such that when a commodity A is purchased, a commodity B also tends to be purchased.

For example, when the purchase correlation of commodities is grasped, stores can intend to enhance the sales of the commodities by, for example, encouraging customers to purchase commodities having a high correlation with each other by using a scheme of Point of Purchase advertising (POP) that encourages customers to easily purchase highly correlated commodities by arranging these commodities close to each other.

The purchase correlation of commodities can be analyzed by using, for example, purchase records being obtained from a Point Of Sale (POS) system and being information of commodities actually purchased by customers. Hereinafter, the purchase record may be referred to as “POS data”.

For example, related arts are disclosed in International Publication Pamphlet No. WO 2018/131214, and Japanese Laid-Open Patent Publication No. 2020-086742.

### SUMMARY

According to an aspect of the embodiments, a non-transitory computer-readable recording medium having stored therein an inverse reinforcement learning program executable by one or more computers, the inverse reinforcement learning program including: an instruction for obtaining movement paths of a plurality of customers that have purchased a first commodity; an instruction for modifying first one or more parameters of a reward function to second one or more parameters, the reward function including a state of a plurality of positions respectively associated with a plurality of commodities including the first commodity, by inverse reinforcement learning based on the movement paths of the plurality of customers under a state where a first parameter related to a first position associated with the first commodity of the reward function is fixed; and an instruction for outputting information representing a relationship between the first commodity and a second commodity based on a second parameter related to a second position associated with the second commodity, the second parameter being included in the second one or more parameters.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of POS data;

FIG. 2 is a diagram illustrating an example of shopping paths of respective customers associated with the POS data of FIG. 1;

FIG. 3 is a diagram illustrating an example of the functional configuration of a server according to one embodiment;

FIG. 4 is a diagram illustrating an example of sections in a store for describing section data;

FIG. 5 is a diagram illustrating an example of shopping path data;

FIG. 6 is a diagram illustrating an example of POS data;

FIG. 7 is a diagram illustrating an example of inverse reinforcement learning;

FIG. 8 is a diagram illustrating an example of a shopping path of a customer;

FIG. 9 is a diagram illustrating an example of reward function coefficient data;

FIG. 10 is a diagram illustrating an example of a purchase correlation data;

FIG. 11 is a flow diagram illustrating an example of the operation of the server according to the one embodiment; and

FIG. 12 is a diagram illustrating an example of the hardware (HW) configuration of a computer that achieves the function of the server of the one embodiment.

### DESCRIPTION OF EMBODIMENT(S)

However, when the relationship between commodities is specified on the basis of POS data, the purchase correlation between the commodities actually purchased by customers is obtained but the relationship between other commodities, i.e., commodities not actually purchased by the customers, is not specified.

For example, a relationship between a commodity purchased by a customer and a commodity that the customer considered (vacillated) to purchase but did not actually purchase (a commodity of weak interest to the customer) and a relationship between the commodities that the customer did not actually purchase are not specified in the analysis based on the POS data.

Hereinafter, an embodiment of the present invention will now be described with reference to the accompanying drawings. However, the embodiment described below is merely illustrative and is not intended to exclude the application of various modifications and techniques not explicitly described below. For example, the present embodiment can be variously modified and implemented without departing from the scope thereof. In the drawings to be used in the following description, the same reference numbers denote the same or similar parts, unless otherwise specified.

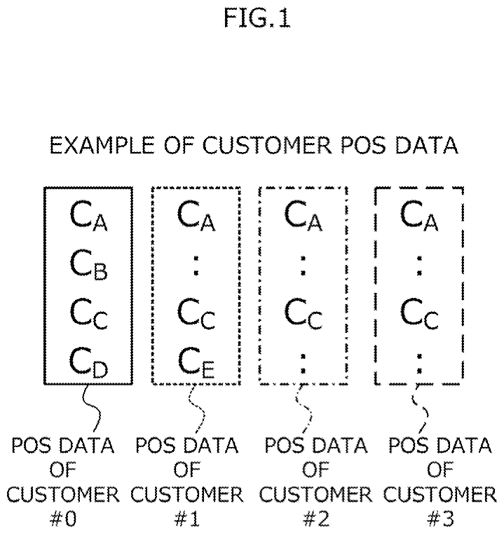

FIG. 1 is a diagram illustrating an example of POS data. The symbols A-E in FIG. 1 are examples of identification information for identifying each commodity purchased by a customer. As illustrated in FIG. 1, the POS data of the customer #0 indicates that the customer #0 purchased the commodities C_{A}, C_{B}, C_{C}, and C_{D}, and the POS data of the customer #1 indicates that the customer #1 purchased the commodities C_{A}, C_{C}, and C_{E}. Similarly, the POS data for the customers #2 and #3 indicate that each of the customers #2 and #3 purchased the commodities C_{A} and C_{C}.

According to the analysis based on the POS data, for example, commodities appearing in a predetermined number or more or a predetermined ratio or more in combination in multiple pieces of POS data have a purchase correlation. Having a purchase correlation may mean that, for example, the commodities are belonging to a category determined to have a high correlation (relationship). In the example of FIG. 1, the commodities C_{A} and C_{C} purchased by the customers #0 to #3 are determined to have a higher purchase correlation.

The commodities having a purchase correlation may mean, for example, that when one (one type) of the commodities is purchased, one or more (one or more types) of the remaining commodities are highly likely to be purchased together (e.g., a given probability or more).

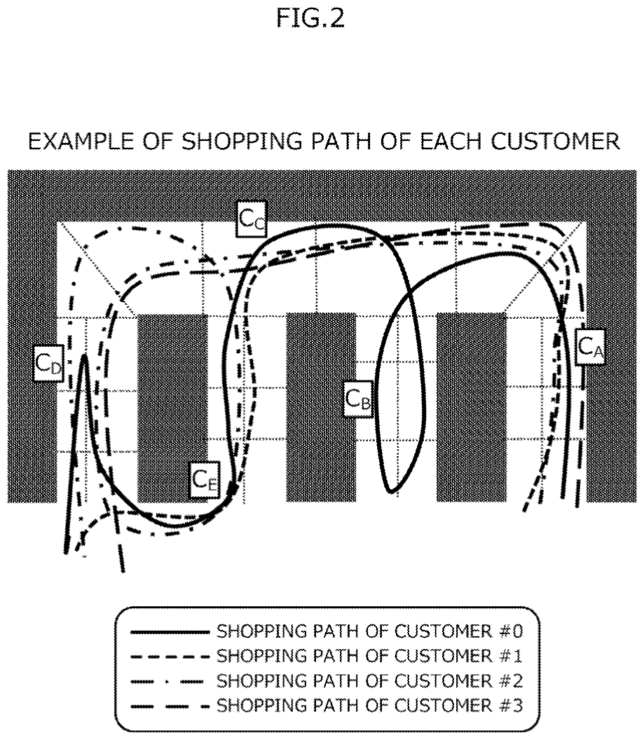

FIG. 2 is a diagram illustrating an example of shopping paths (i.e., loci of shopping) of customers corresponding to the POS data illustrated in FIG. 1. In FIG. 2, the arrangement of the commodity shelves and the commodities C_{A} to C_{E} in the store is represented by an arrangement diagram (plan view) of the store, and the respective shopping paths of the customers passing through a passage between the commodity shelves are illustrated by a solid line (for the customer #0), a short dashed line (for the customer #1), a one-doted dashed line (for the customer #2), and a long dashed line (for the customer #3).

From the shopping paths of the customers illustrated in FIG. 2, many customers pass near the commodity C_{E}. According to the POS data illustrated in FIG. 1, the customer #1 purchased the commodity C_{E}.

Collectively judging from the purchase correlation of the commodities C_{A} and C_{C} obtained from the POS data illustrated in FIG. 1 and the respective shopping paths of the customers illustrated in FIG. 2, it can be said that a customer who buys the commodities C_{A} and C_{C} are also interested in the commodity C_{E}.

Thus, in the analysis of the POS data illustrated in FIG. 1, in other words, the actual purchase record of customers, the “weak interest” (see FIG. 2) that the customer tried to purchase but did not actually purchase is ignored.

Therefore, the one embodiment will describe a method for obtaining a relationship between commodities including commodities (e.g., the commodity C_{E}) which are not purchased by customers by incorporating such “weak interest” into the purchase correlation (commodity correlation) of commodities and for thereby improving the sales of stores.

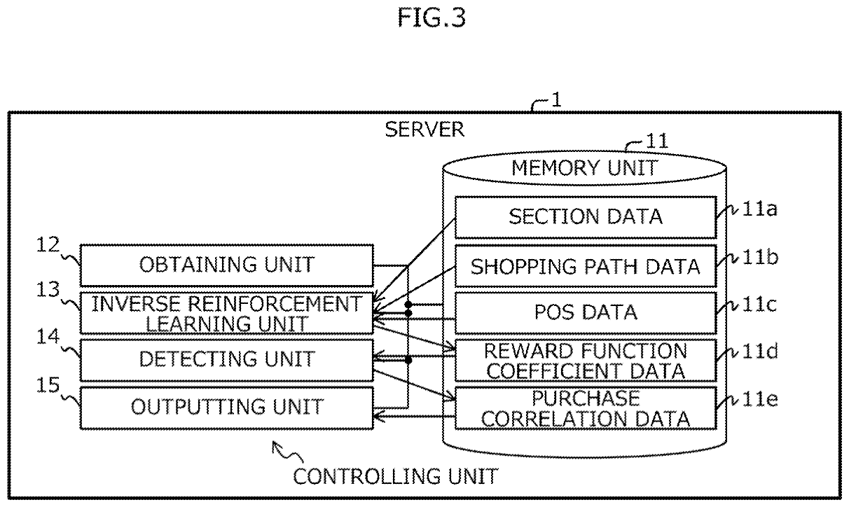

FIG. 3 is a block diagram illustrating an example of the functional configuration of a server 1 according to the one embodiment. The server 1 is an example of an inverse reinforcement learning apparatus or an information processing apparatus, and may be, for example, a purchase behavior analyzing apparatus that analyzes purchase behavior of customers on the basis of various information of the customers.

As illustrated in FIG. 3, the server 1 may illustratively include a memory unit 11, an obtaining unit 12, an inverse reinforcement learning unit 13, a detecting unit 14, and an outputting unit 15. The obtaining unit 12, the inverse reinforcement learning unit 13, the detecting unit 14, and the outputting unit 15 collectively serve as an example of a controlling unit 16.

The memory unit 11 is an example of a storing region and stores various kinds of information used for processing performed by the server 1. As illustrated in FIG. 3, the memory unit 11 may be capable of storing, for example, section data 11a, shopping path data lib, POS data 11c, reward function coefficient data 11d, and purchase correlation data 11e. Each of the section data 11a, the shopping path data lib, the POS data 11c, the reward function coefficient data 11d, and the purchase correlation data 11e may be stored in the memory unit 11 in any of various formats such as a table format, a Database format, and an array format.

The obtaining unit 12 obtains at least part of the information used for the execution of the processing by the inverse reinforcement learning unit 13, for example, the section data 11a, the shopping path data lib, and the POS data 11c from a non-illustrated computer.

The section data 11a is data related to sections in a store, for example, information indicating a relationship between sections of passages between commodity shelves and sections that commodities to be placed (displayed) on the commodity shelves face.

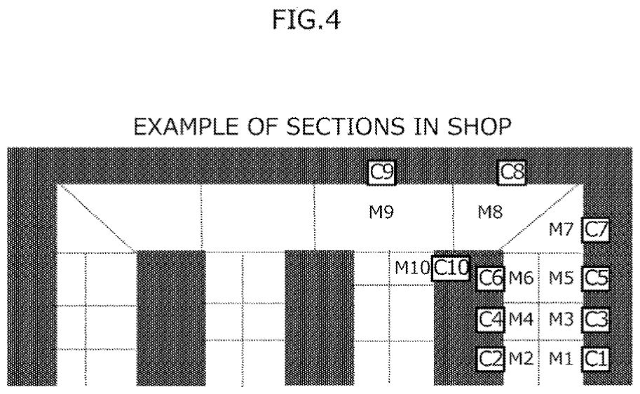

FIG. 4 is a diagram illustrating an example of sections in a store for explaining the section data 11a. FIG. 4 illustrates an example in which a passage between commodity shelves indicated by shading is divided into multiple sections in mesh shapes indicated by dotted lines. As illustrated in FIG. 4, identification information (omitting “M11” and the subsequent thereto) of each section may be set by combining a symbol “M” indicating a section and a number starting from “1”.

Further, as illustrated in FIG. 4, identification information (omitting “C11” and subsequent thereto) of each commodity arranged at a position (e.g., a commodity shelf) facing a section M may be set by combining a symbol “C” indicating a commodity and a number starting from “1”. For simplicity, FIG. 4 assumes a case where one product C is disposed at a position facing one section M. Further, in the following description, a commodity is denoted as, for example, C_{A} by replacing the numeric portion of the identification information of a commodity C with an alphabet (see FIG. 2). Similarly, in the following description, a section may be denoted as, for example, M_{A} by replacing the numeric portion of the identification information of a section M with an alphabet (see FIG. 2).

The section data 11a may set an association relationship between a section Mx and a commodity Cy based on the example of the sections illustrated in FIG. 4. The symbol x is an integer of one or more corresponding to the numerical portion of the identification information of the section M, and the symbol y is an integer of one or more or an alphabet corresponding to the numerical portion of the identification information of the commodity C. For example, the section data 11a may store information in which the section Mx and the commodity Cy disposed at the position facing (belonging to) the section Mx are associated with each other.

The section data 11a may include, for example, at least one of information indicating the position (e.g., coordinate) of each section M in the store, information indicating the neighboring relationship between the sections M (e.g., identification information of a neighboring partition M), and information capable of expressing (reproducing) an example of the sections. Alternatively, these pieces of information may be stored in the memory unit 11 separately from the section data 11a.

The shopping path data 11b is information indicating a shopping path (or “locus”) of each customer in a store, and may be, for example, information indicating sections M through which each customer has passed over time. The shopping path (shopping locus) of a customer is an example of a movement path of the customer.

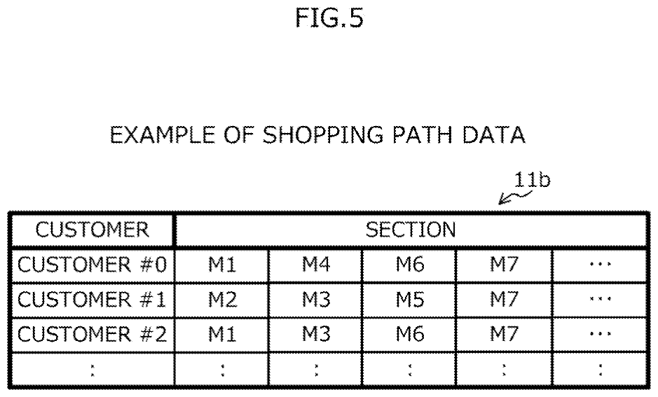

FIG. 5 is a diagram illustrating an example of the shopping path data 11b. As illustrated in FIG. 5, the shopping path data 11b may illustratively include fields of “customer” and “section”. The field of “customer” may be set with identification information of a customer. The field of “section” may include identification information of multiple sections M in such a manner that the order of passage (shopping) by the “customer” can be distinguished. As an example, in the shopping path data 11b of FIG. 5, the order of passage of the customer #0 is M1, M4, M6, M7, . . . .

The obtaining unit 12 may obtain the shopping path of each customer by various methods. For example, the obtaining unit 12 may obtain the shopping path data 11b generated by a system that obtains the movement path of a customer from the system. Alternatively, the obtaining unit 12 may obtain information of the movement path of each customer in the store from the system, and generate the shopping path data 11b based on the obtained information. In addition, the obtaining unit 12 may set the information of the section M of the shopping path data 11b based on the section data 11a.

As described above, the obtaining unit 12 obtains the movement paths of multiple customers who purchased a first commodity C_{A} and a second commodity C_{C}.

Examples of the system for obtaining the shopping paths of movement of customers include a system for tracking tags such as Radio Frequency (RF) tags attached to shopping baskets or carts, and a system for analyzing images captured by an imaging device such as a surveillance camera installed in a store.

The POS data 11c is information of commodities actually purchased by customers, and is an example of a purchase record of the customers. The POS data 11c may be obtained from a POS system.

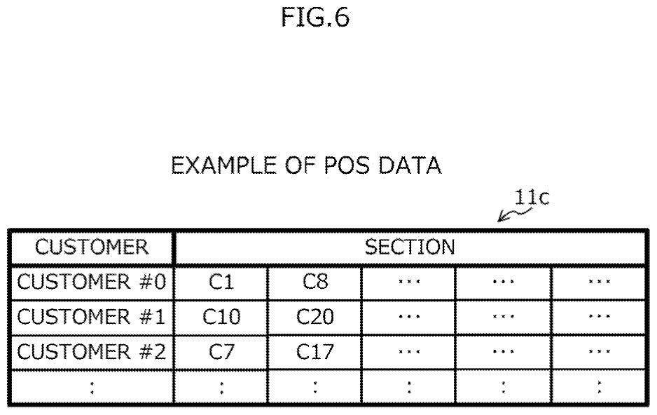

FIG. 6 is a diagram illustrating an example of the POS data 11c. As illustrated in FIG. 6, the POS data 11c may illustratively include fields of “customer” and “commodity”. The field of “customer” may be set with identification information of a customer. The field of “commodity” may include identification information of multiple commodities C purchased by the “customer”. As an example, the POS data 11c illustrated in FIG. 6 is set with that the commodities C of C1, C8, . . . were purchased by the customer #0.

The obtaining unit 12 may obtain the purchase record of the customer by various methods. For example, the obtaining unit 12 may obtain the POS data 11c totaled and generated by a POS system from the POS system. Alternatively, the obtaining unit 12 may obtain information on the purchase of commodities of each customer in the store from the POS system, and generate the POS data 11c based on the obtained information.

The identification information of the “customer” included in the shopping path data 11b and the identification information of the “customer” included in the POS data 11c may be common identification information or may be identification information that can be associated with each other via other information. In other words, the shopping path data 11b and the POS data 11c may be regarded as information in which the commodity C purchased by each customer and the sections M (shopping path) passed by the customer are associated with each other by using the identification information of the customer as a key.

The inverse reinforcement learning unit 13 performs inverse reinforcement learning, using the shopping path data 11b and the POS data 11c, and stores the reward function coefficient data 11d obtained by the inverse reinforcement learning into the memory unit 11.

For example, the inverse reinforcement learning unit 13 applies a method of inverse reinforcement learning to the shopping path data 11b and the POS data 11c on the basis of the section data 11a. The inverse reinforcement learning process by the inverse reinforcement learning unit 13 and the reward function coefficient data 11d will be detailed below.

The detecting unit 14 detects the purchase correlation (commodity correlation) considering the shopping paths based on the reward function coefficient data 11d, and stores the detected purchase correlation, as the purchase correlation data 11e, into the memory unit 11. The detecting unit 14 can detect the purchase correlation considering “weak interest” by considering the shopping paths. For example, with respect to a certain commodity C, the detecting unit 14 detects a commodity C having a large coefficient value of a reward function of customer behavior as a correlated commodity.

The outputting unit 15 outputs the purchase correlation data 11e obtained by the detecting unit 14 as outputted data. For example, the outputting unit 15 may transmit the purchase correlation data 11e itself to another computer (not illustrated), or may store the purchase correlation data 11e in the memory unit 11 and manage the data 11e referable from the server 1 or another computer. Alternatively, the outputting unit 15 may output information indicating the purchase correlation data 11e on a screen of an output device such as the server 1.

The outputting unit 15 may output, as the outputted data, various data in place of or in addition to the purchase correlation data 11e itself. The outputted data may be various data exemplified by an analysis result of the purchase behavior of customers based on the purchase correlation data 11e, intermediate generation information in the inverse reinforcement learning process, or intermediate generation information in the analyzing process of the purchase behavior.

As described above, according to the server 1, the inverse reinforcement learning unit 13 and the detecting unit 14 can detect the purchase correlation considering “weak interest” such as a commodity C that the customer did not purchased in spite of approaching the shelf thereof through the analysis based on the customer's shopping path.

This makes it possible to obtain the relationship of purchase of multiple commodities including commodities that are not purchased by a customer, in other words, to obtain a more accurate purchase correlation, so that analysis of the purchase behavior of the customers based on, for example, the purchase correlation achieves improvement in sales of the commodities in the store.

Next, description will now be made in relation to an inverse reinforcement learning process performed by the inverse reinforcement learning unit 13.

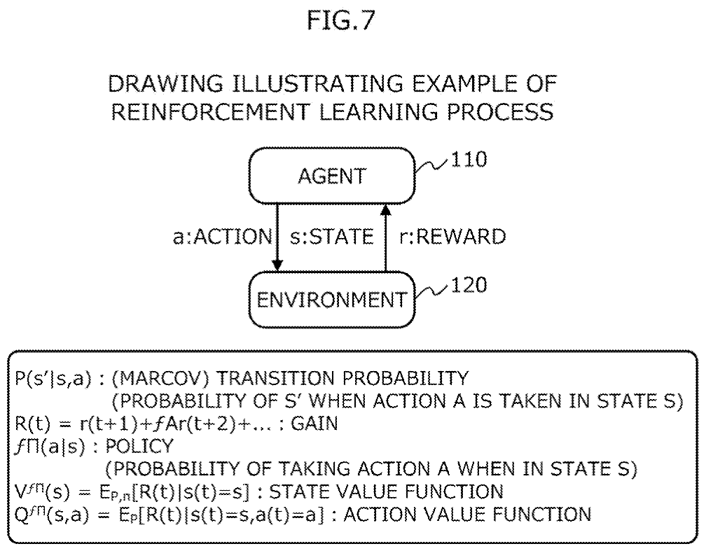

First, description will now be made in relation to the reinforcement learning process. FIG. 7 is a diagram illustrating an example of a reinforcement learning process. The reinforcement learning process is a process of performing machine learning of a model for detecting an action a performed by an agent (which may be referred to as a “controller”) 110. For example, the reinforcement learning process assumes a model that gives a reward r when the agent 110 performs a certain action a (action) in the environment 120 of a state s (state).

The agent 110 is, for example, a shopper (customer), and performs an action a that heighten the reward r. The action a is, for example, shopping. The total amount (sum) of the rewards r is the gain R(t), as expressed in the following Equation (1). In the following Equation (1), the symbol t represents time, and the symbol γ represents a discount rate to reduce the reward r over time.

R(t)=r(t+1)+γr(t+2)+ (1)

Incidentally, a dynamic programming method has been known which obtains, when the reward r and the transition probability P are known, the policy Π(a|s) that maximizes the value (V,Q). For example, the Bellman equation may be used for the dynamic programming method.

In contrast to the above, the reinforcement learning process may include a process of finding a policy that maximize the value (V,Q) while performing the machine learning of the model with real data when the reward r and the transition probability P are unknown (black box).

An example of the transition probability P is a transition probability in the Markov Decision Process (MDP). For example, the transition probability P which becomes the state s′ at the time of (s,a) may be expressed as P(s|s,a).

The policy Π(a|s) is the probability that action a will take place in a state s. For example, in a dynamic programming method, the state s and the action a that maximize the Q(s,a) may be obtained. The values (V,Q) may include a state value function V^{Π}(s) and an action value function Q^{Π}(s,a). The state Value Function V^{Π}(s) and the Action Value Function Q^{Π}(s,a) may be represented by the following Equations (2) and (3), respectively. In the following equations (2) and (3), the symbol E represents an expected value.

V^{Π}(s)=E_{P,Π}[R(t)|s(t)=s] (2)

Q^{Π}(s,a)=Eₚ[R(t)|s(t)=s,a(t)=a] (3)

As described above, the reinforcement learning process is a method for obtaining, when the gain R (reward r) is unknown, the policy that maximizes the gain R by using data obtained by the agent 110 repeatedly calculating the gain R in a try-and-error manner that changes the state s and the action a. The reinforcement learning process is an example of Q learning, for example, deep Q learning in which Q(s,a) is modeled by Deep Learning (DL), and may be referred to as “policy learning”.

The trained model by the reinforcement learning process can obtain the chronological state s and action a of the agent 110, that is, the movement path of the agent 110.

An inverse reinforcement learning process is a method of estimating a gain (cost) function that achieves a path (result) of the reinforcement learning process when the path is given. As an example, the inverse reinforcement learning process may perform a machine learning process of a model for obtaining a gain function that achieves an certain action a on an assumption that, when an agent takes the action a, the action is a result of movement of the agent in accordance with a certain reward r. The inverse reinforcement learning process may use, for example, a maximum entropy method, but the present invention is not limited thereto, and various known methods may be used.

The gain function of (s,a) may be expressed as r(s,a;θ), using (s,a) and a parameter vector θ. The gain function r(s,a;θ) may be expressed by the following Equation (4). In the following Equation (4), φ(s,a) is a feature vector, and may be information obtained by accumulating actions (paths) such as the state s and the action a of the agent 110, in other words, the shopping area or the direction that the agent 110 will go next.

r(s,a;θ)=θ·φ(s,a) (4)

In the above equation (4), the medium black dot ( ) represents an inner product. In the maximum entropy method, a gain function may be represented by a linear function of a feature vector, for example.

Here, in the reverse reinforcement learning process, it is assumed that the agent 110 selects the observation path {ζ} on the transition probability P (ζᵢ;θ) expressed in the following Equation (5). The observation path {ζᵢ} may include a state sᵢ and an action aᵢ of the agent 110 in each of 1 to Ni, as expressed in the following Equation (6). In the following Equation (5), the term Z(θ) is a normalized constant for making P (ζᵢ theta) a probability (0 or more to 1 or less), and may be, for example, represented by the following Equation (5-1). In the following Equation (6), i(1), i(2), . . . , and i(Ni) represent time series of mesh numbers through which the path passed. In other words, the path means that the path went through the mesh in the order of M_{>i(1)}, Mᵢ₍₂₎), . . . , M_{iN(i)}. Ni is the total number of meshes through which the path ζᵢ has passed. The terms _{ai(1), . . . ai(Ni)} mean the directions in which the customer is heading next in their respective meshes, e.g. up, down, right or left, starting from the present mesh. The direction can be determined from the path.

P(ζᵢ;θ)=exp(Σ<sj,aj>∈ζiθ·φ(sⱼ,aⱼ))/Z(θ) (5)

Z(θ)=Σᵢ exp(Σ<sj,aj>∈ζiθ·φ(sj,aj)) (5-1)

{ζᵢ}={<sᵢ₍₁₎,aᵢ₍₁₎>, . . . ,<s_{i(Ni)},a_{i(Ni)}>} (6)

The parameter vector θ* optimized by maximizing the likelihood in the transition probability P(ζᵢ;θ) expressed by the above Equation (5) may be calculated according to the following Equation (7). The argmax is a function that obtains the set of the largest points.

θ*=argmax Σᵢ log(P(ζᵢ;θ)) (7)

The inverse reinforcement learning process may adopt the method described in, for example, ““Maximum Entropy Inverse Reinforcement Learning”, B. Ziebart, A. Maas, et. al., Proc. of the 23rd AAAI (2008)”.

The inverse reinforcement learning unit 13 according to the one embodiment obtains a gain function r(s,a;θ) by solving an optimization problem for obtaining the parameter vector θ in which the observation path {ζᵢ} reproduces the actual path (shopping path of a customer) by the above-described inverse reinforcement learning process. In the following description, the gain function r(s,a;θ) may be referred to as a “reward function”.

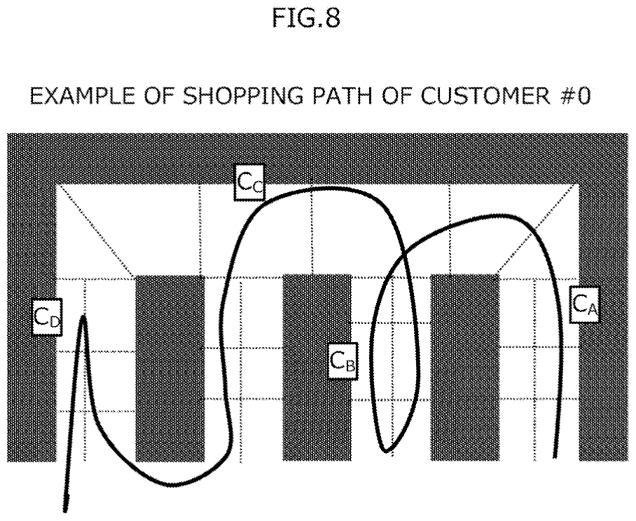

FIG. 8 is a diagram illustrating an example of a shopping path of the customer #0. For example, FIG. 8 assumes that the customer #0 purchased the commodities C_{A}, C_{B}, C_{C}, and C_{D} in the POS data 11c, and that the customer #0 moved around the shopping path illustrated in FIG. 8 in the shopping path data 11b.

The inverse reinforcement learning unit 13 trains a machine learning model for outputting a reward function that reproduces the shopping path of the customer #0 based on the shopping path data 11b and the POS data 11c.

For example, the state s is information indicating a section in which the customer #0 exists among the multiple sections (meshes) M. As an example, the state s may be information in which “1” is set in a coordinate corresponding to the number i of the mesh M in which the customer #0 is located, such as a vector sᵢ=(0, . . . , 0, 1, . . . , 0) of the mesh numbers 0-1.

The reward function may be expressed by the following Equation (8) based on the above Equations (4), (5), and (7).

In the following Equation (8), θ₁ is an example of a parameter of the reward function, and indicates, for example, the degree of interest of a commodity C arranged at a position facing (belonging to) the mesh i (section Mi). The degree of interest of the commodity C is an index indicating the degree of interest of the commodity C by the customer #0, and a high degree of interest means that the probability (likelihood) that the customer #0 moves to the commodity C is high.

The reward function: θ₁*s₁+ . . . +θ_{N}*s_{N} (8)

In the training of the machine learning model, the inverse reinforcement learning unit 13 performs the inverse reinforcement learning process using the shopping path data 11b under a state where the parameter θ of the section Mᵢ in which the commodity C (POS data 11c) purchased by the customer #0 is positioned is fixed to a sufficiently large value. For example, the inverse reinforcement learning unit 13 updates the respective parameters θ (θ₁) such that an output that reproduces the shopping path of the client #0 can be obtained.

The reward function is obtained by multiplying the state sᵢ (state vector) by a parameter θᵢ serving as a coefficient as expressed in the above Equation (8), and can therefore be said that the value of the coefficient θᵢ increases at a place where the reward is high (section Mi). Therefore, the inverse reinforcement learning unit 13 fixes the coefficient θ to a sufficiently large value for the section i corresponding to the commodity C purchased by the customer #0, in other words, for the section Mi known to have a high reward.

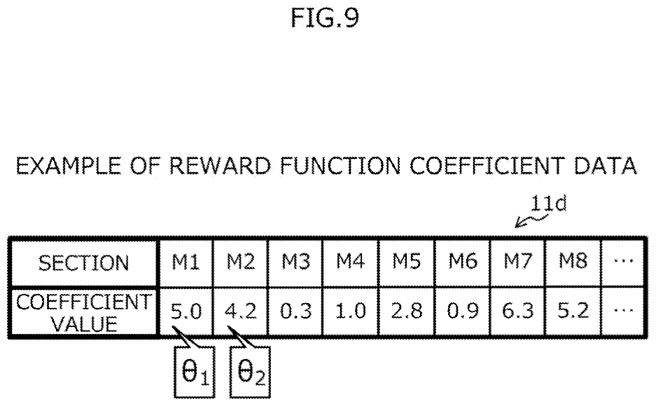

FIG. 9 is a diagram illustrating an example of the reward function coefficient data 11d. As illustrated in FIG. 9, the reward function coefficient data 11d may illustratively include fields of “section” and “coefficient value”. The field of “section” may be set with identification information of each section M. The field of “coefficient value” may be set with a coefficient θᵢ associated with the section Mi.

In cases where multiple commodities C are associated (arranged) with one section M, the reward function coefficient data 11d may be set with “commodities” indicating identification information of each commodity C in place of or in addition to “section”.

The inverse reinforcement learning unit 13 may extract (obtain) the coefficient θ of the reward function from the model trained by the inverse reinforcement learning process to generate the reward function coefficient data 11d and store the data 11d in the memory unit 11.

As described above, the inverse reinforcement learning unit 13 outputs the reward function coefficient data 11d that reproduces the shopping path of the multiple customers who purchased the combination (set) of one or more same commodities C on the basis of the shopping path data 11b of the customers who purchased the combination. In other words, the inverse reinforcement learning unit 13 may generate the reward function coefficient data 11d by performing the inverse reinforcement learning process for each same combination of one or more commodities C for which the purchase correlation is to be detected.

For example, the inverse reinforcement learning unit 13 extracts the customer who has purchased the commodities C_{A} and C_{C} from the POS data 11c. Then, the inverse reinforcement learning unit 13 performs inverse reinforcement learning under a state where the coefficients θ_{A} and θ_{C} corresponding to the commodities C_{A} and C_{C} are fixed to high values on the basis of the shopping path data 11b of each of the extracted customers. Such high values are, for example, values equal to or higher than a given value at which the detecting unit 14 to be described below detects that corresponding commodities have a purchase correlation, and is, for example, values equal to or higher than a given threshold value described below. The inverse reinforcement learning process updates the parameters θ of the reward function respectively including the state s indicated by the multiple positions M_{A} and M_{C} associated with each of the multiple commodities including the first commodity C_{A} and the second commodity C_{C}.

As described above, the inverse reinforcement learning unit 13 updates the parameter θ of the reward function by the inverse reinforcement learning based on the movement paths of the multiple of customers in a state where the first parameter θA for the first position M_{A} associated with the first commodity C_{A} and the second parameter θ_{C} for the second position M_{C} associated with the second commodity C_{C} of the reward function are fixed.

The customer who purchased the combination of one or more commodities C (e.g., commodities C_{A} and C_{C}) may be, for example, a customer who purchased only the commodities C_{A} and C_{C} among the multiple commodities C, or a customer who has purchased multiple commodities C including at least the commodities C_{A} and C_{C}. Further, the above-described example assumes that the one or more commodities C are the first commodity C_{A} and the second commodity C_{C}, but the present invention is not limited to this. Alternatively, the present invention can be applied to a case of a single commodity C (e.g., a first commodity C_{A}).

For example, when one or more commodities C are a single commodity C (e.g., a first commodity C_{A}), the obtaining unit 12 may obtain the shopping path data 11b of multiple customers who purchased the first commodity C_{A}. Further, the inverse reinforcement learning unit 13 may update the parameter θ of the reward function by inverse reinforcement learning based on the movement paths of the multiple customers in a state where the first parameter OA of the first position M_{A} associated with the first commodity C_{A} of the reward function including the state s indicated by the multiple positions Mᵢ associated one with each of the multiple commodities including the first commodity C_{A} is fixed.

The detecting unit 14 generates the purchase correlation data 11e based on the reward function coefficient data 11d generated by the inverse reinforcement learning unit 13 and stores the generated data 11d into the memory unit 11.

As described above, the inverse reinforcement learning process increases the coefficient θ1 in a place (section Mᵢ) where the reward is high. As an example, in the reward function coefficient data 11d related to the commodities C_{A} and C_{C}, the values of θ_{A} and θ_{C} corresponding to the sections M_{A} and M_{C} are increased. Further, when the customers who purchased the commodities C_{A} and C_{C} frequently pass through the section M_{E} of the commodity C_{E}, in other words, if the customers are interested in the commodity C_{E}, the value of θE associated with the section M_{E} in the reward function coefficient data 11d also increases.

Therefore, the detecting unit 14 may compare the value of each parameter vector θᵢ of the reward function coefficient data 11d with a given threshold, and detect multiple commodities Ci (section Mᵢ) each having a θᵢ equal to or greater than the given threshold, for example, the commodities C_{A}, C_{C}, and C_{E}, as the commodities C having a purchase correlation. The given threshold value may be a fixed value or a variable value. If being a variable value, for example, the given threshold may be calculated by various methods such as an average value of the values of the coefficients θᵢ or a median value of the coefficients θᵢ included in the reward function coefficient data 11d.

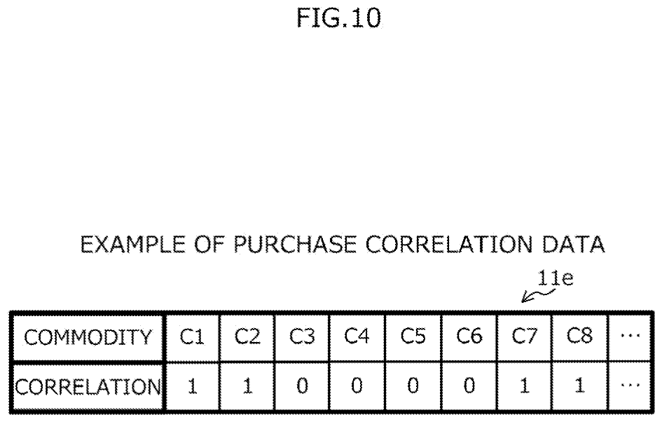

FIG. 10 is a diagram illustrating an example of the purchase correlation data 11e. As illustrated in FIG. 10, the purchase correlation data 11e may include fields of “commodity” and “correlation” by way of example. The field of “commodity” may be set with identification information of each commodity C. The field of “correlation” may be set with a detection result of the purchase correlation corresponding to the commodity Ci (section Mi) which purchase correlation is based on the reward function coefficient data 11d.

As an example, the field of “correlation” of a commodity Ci determined to have a purchase correlation, in other words, that of a commodity having a value of θᵢ equal to or greater than the given threshold, may be set to “1”. In contrast, the field of “correlation” of a commodity Ci determined not to have a purchase correlation, in other words, a commodity having a value of θᵢ less than the given thresh, may be set to “0”.

In the purchase correlation data 11e, multiple commodities Ci in which “1” is set in the respective fields of “correlation” can be said to be commodities Ci having a high purchase correlation, in other words, commodities Ci having a high possibility of being purchased simultaneously (in one purchase) by a customer. For example, in cases where the combination of one or more commodities includes the first commodity C_{A} and the second commodity C_{C} and the coefficient θ_{E} of a third commodity C_{E} is the given threshold or more, the purchase correlation data 11e is information indicating that the first commodity C_{A}, the second commodity C_{C}, and the third commodity C_{E} have a purchase correlation. For example, in cases where (the combination of) one or more commodities is a first commodity C_{A} and the coefficient θ_{E} of a second commodity C_{E} is the given threshold or more, the purchase correlation data 11e is information indicating that the first commodity C_{A} and the second commodity C_{E} have a purchase correlation.

The purchase correlation data 11e illustrated in FIG. 10 is an example of a result of a detecting process of the purchase correlation that the detecting unit 14 carries out on the reward function coefficient data 11d illustrated in FIG. 9, assuming that the predetermined threshold value is “4.0”.

As described above, the detecting unit 14 generates information indicating the relationship among the first commodity C_{A}, the second commodity C_{C}, and the third commodity C_{E}, which information is exemplified by the purchase correlation data 11e, on the basis of the third parameter θ_{E} for the third position M_{E} corresponding to the third commodity C_{E} included in the updated reward function. Further, when one or more commodities C are a single commodity C (for example, a first commodity C_{A}), the detecting unit 14 generates information indicating the relationship between the first commodity C_{A} and the second commodity C_{E}, which information is exemplified by the purchase correlation data 11e, on the basis of the second parameter θ_{E} for the second position M_{E} corresponding to the second commodity C_{E} included in the updated reward function. The purchase correlation data 11e generated by the detecting unit 14 may be output by, for example, the outputting unit 15.

As described above, according to the server 1 of the one embodiment, the purchase correlation of the commodities C in consideration of the customer's interest can be detected by the scheme of the inverse reinforcement learning process based on the shopping path data 11b of the customers and the POS data 11c. Further, according to the server 1, it is possible to improve sales by using the detected purchase correlation.

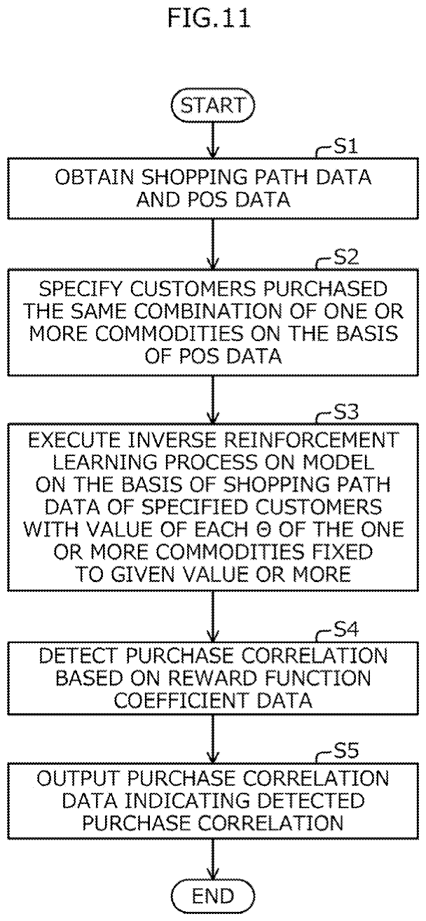

Next, description will now be made in relation to an example of operation of the server 1 according to the above-described one embodiment with reference to FIG. 11. FIG. 11 is a flowchart illustrating an example of operation of the server 1 according to the one embodiment. As illustrated in FIG. 11, the obtaining unit 12 of the server 1 obtains the shopping path data 11b and the POS data 11c (Step S1).

For example, the inverse reinforcement learning unit 13 identifies one or more customers who purchased the same combination of one or more commodities C on the basis of the POS data 11c for one or more commodities C for which the purchase correlation is to be detected according to the instruction by the user (Step S2).

The inverse reinforcement learning unit 13 fixes the value of the coefficient θ of each of the one or more commodities to a value equal to or larger than a given value (e.g., equal to or larger than the given threshold), and performs the inverse reinforcement learning process of the model on the basis of the shopping path data 11b of the specified customers (Step S3).

The detecting unit 14 detects a purchase correlation related to the one or more commodities for which a purchase correlation is to be detected, on the basis of the reward function coefficient data 11d which is a part of the parameters of the trained model (Step S4), and stores the purchase correlation data 11e representing the purchase correlation into the memory unit 11.

The outputting unit 15 outputs the purchase correlation data 11e indicating the purchase correlation detected by the detecting unit 14 (Step S5), and the process ends.

The server 1 may execute the processing of Steps S1 to S5 described above every time one or more commodities are designated as the detection targets of the purchase correlation by the user.

The server 1 according to the embodiment may be a virtual server (Virtual Machine (VM)) or a physical server. The functions of the server 1 may be achieved by one computer or by two or more computers. Further, at least some of the functions of the server 1 may be implemented using Hardware (HW) resources and Network (NW) resources provided by cloud environment.

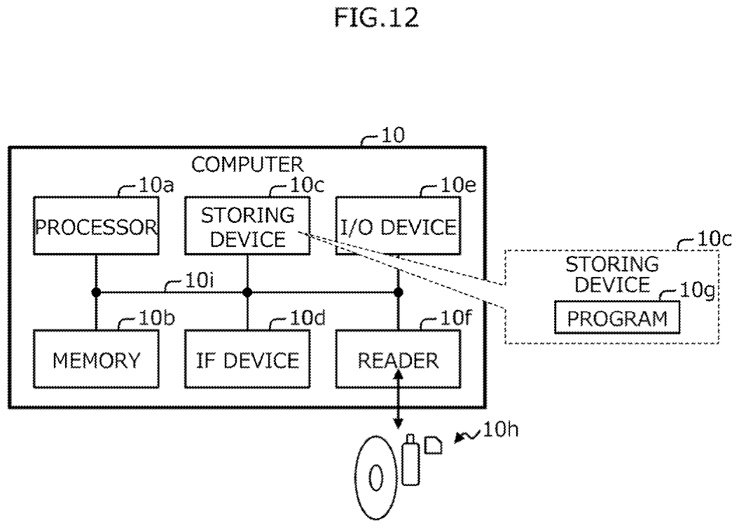

FIG. 12 is a block diagram illustrating an example of the hardware (HW) configuration of a computer 10 that achieves the functions of the server 1. If multiple computers are used as the HW resources for achieving the functions of the server 1, each of the computers may include the HW configuration illustrated in FIG. 12.

As illustrated in FIG. 12, the computer 10 may illustratively include a HW configuration formed of a processor 10a, a memory 10b, a storing device 10c, an I/F device 10d, an I/O device 10e, and a reader 10f.

The processor 10a is an example of an arithmetic operation processing device that performs various controls and calculations. The processor 10a may be communicably connected to the blocks in the computer 10 via a bus 10i. The processor 10a may be a multiprocessor including multiple processors, may be a multicore processor having multiple processor cores, or may have a configuration having multiple multicore processors.

The processor 10a may be any one of integrated circuits (ICs) such as Central Processing Units (CPUs), Micro Processing Units (MPUs), Digital Signal Processors (DSPs), Application Specific Integrated Circuits (ASICs), and Programmable Logic Devices (PLDs) (e.g., Field Programmable Gate Arrays (FPGAs)), or combinations of two or more of these ICs.

The memory 10b is an example of a HW device that stores various types of data and information such as a program. Examples of the memory 10b include one or both of a volatile memory such as a Dynamic Random Access Memory (DRAM) and a non-volatile memory such as Persistent Memory (PM).

The storing device 10c is an example of a HW device that stores various types of data and information such as program. Examples of the storing device 10c include a magnetic disk device such as a Hard Disk Drive (HDD), a semiconductor drive device such as a Solid State Drive (SSD), and various storing devices such as a nonvolatile memory. Examples of the nonvolatile memory include a flash memory, a Storage Class Memory (SCM), and a Read Only Memory (ROM).

The information 11a to 11e stored in the memory unit 11 illustrated in FIG. 3 may be stored in one or the both of the storing region included in the memory 10b and storing device 10c.

The storing device 10c may store a program 10g (inverse reinforcement learning program) that implements all or part of various functions of the computer 10. For example, the processor 10a of the server 1 can achieve the functions of the server 1 (for example, the controlling unit 16) illustrated in, for example, FIG. 3 by expanding the program 10g stored in the storing device 10c onto the memory 10b and executing the expanded program 10g.

The I/F device 10d is an example of a communication IF that controls connection and communication with one or the both of the networks. For example, the I/F device 10d may include an applying adapter conforming to Local Area Network (LAN) such as Ethernet (registered trademark) or optical communication such as Fibre Channel (FC). The applying adapter may be compatible with one of or both wireless and wired communication schemes. For example, the server 1 may be communicably connected to a non-illustrate computer. Furthermore, the program log may be downloaded from the network to the computer through the communication IF and be stored in the storing device 10c.

The I/O device 10e may include one or both of an input device and an output device. Examples of the input device include a keyboard, a mouse, and a touch panel. Examples of the output device include a monitor, a projector, and a printer.

The reader 10f is an example of a reader that reads data and programs recorded on a recording medium 10h. The reader 10f may include a connecting terminal or device to which the recording medium 10h can be connected or inserted. Examples of the reader 10f include an applying adapter conforming to, for example, Universal Serial Bus (USB), a drive apparatus that accesses a recording disk, and a card reader that accesses a flash memory such as an SD card. The program 10g may be stored in the recording medium 10h. The reader 10f may read the program 10g from the recording medium 10h and store the read program 10g into the storing device 10c.

The recording medium 10h is an example of a non-transitory computer-readable recording medium such as a magnetic/optical disk, and a flash memory. Examples of the magnetic/optical disk include a flexible disk, a Compact Disc (CD), a Digital Versatile Disc (DVD), a Blu-ray disk, and a Holographic Versatile Disc (HVD). Examples of the flash memory include a semiconductor memory such as a USB memory and an SD card.

The HW configuration of the computer 10 described above is exemplary. Accordingly, the computer 10 may appropriately undergo increase or decrease of HW devices (e.g., addition or deletion of arbitrary blocks), division, integration in an arbitrary combination, and addition or deletion of the bus. For example, in the server 1, at least one of the I/O device 10e and the reader 10f may be omitted.

The technique according to the one embodiment described above can be changed or modified as follows.

For example, the processing functions 12 to 15 included in the server 1 illustrated in FIG. 3 may be merged or divided in any combination.

Further, if not using the section data 11a in the inverse reinforcement learning process and the detecting process of the purchase correlation, the server 1 is allowed to have a configuration of the memory unit 11 not storing the section data 11a.

Further, in one embodiment, the memory unit 11 may store one or the both of the shopping path data 11b and the POS data 11c only of a group of customers having a predetermined attribute, for example, in a customer category having a specific characteristic. Example of the customer category is determined according to the customer attribute, such as, male customers, female customers, young customers, and elder customers. By limiting the customer category in this manner, the server 1 can detect a purchase correlation specific to the limited customer category.

The server 1 illustrated in FIG. 3 may have a configuration in which multiple apparatuses cooperate with each other via a network to achieve the respective processing functions. For example, the obtaining unit 12 and the outputting unit 15 may be a web server, the inverse reinforcement learning unit 13 and the detecting unit 14 may be an application server, and the memory unit 11 may be a Database server. In this case, the processing function as the server 1 may be achieved by the web server, the application server, and the DB server cooperating with one another via a network.

In one aspect, the above one embodiment can obtain the relationship of multiple commodities, including ones not purchased by a customer.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein an inverse reinforcement learning program executable by one or more computers, the inverse reinforcement learning program comprising:
an instruction for obtaining movement paths included in a plurality of customers that have purchased a first commodity;
an instruction for modifying first one or more parameters of a reward function to second one or more parameters, the reward function including a state of a plurality of positions respectively associated with a plurality of commodities including the first commodity, by inverse reinforcement learning based on the movement paths of the plurality of customers under a state where a first parameter related to a first position associated with the first commodity of the reward function is fixed; and
an instruction for outputting information representing a relationship between the first commodity and a second commodity based on a second parameter related to a second position associated with the second commodity, the second parameter being included in the second one or more parameters.

2. The non-transitory computer-readable recording medium according to claim 1, wherein
the modifying includes modifying the first one or more parameters of the reward function to the second one or more parameters by the inverse reinforcement learning based on the movement paths of the plurality of customers under a state where the first parameter is set to be a given value or more, and
the outputting includes outputting the information based on a result of comparing the second parameter included in the updated reward function with a threshold.

3. The non-transitory computer-readable recording medium according to claim 2, wherein
the outputting includes, when the second parameter included in the updated reward function is equal to or more than the threshold, outputting the information representing that the first commodity and the second commodity have a purchase correlation with each other.

4. The non-transitory computer-readable recording medium according to claim 1, wherein
the plurality of customers have an attribute among customers that have purchased the first commodity.

5. A computer-implemented method for inverse reinforcement learning comprising:
obtaining movement paths included in a plurality of customers that have purchased a first commodity;
modifying first one or more parameters of a reward function to second one or more parameters, the reward function including a state of a plurality of positions respectively associated with a plurality of commodities including the first commodity, by inverse reinforcement learning based on the movement paths of the plurality of customers under a state where a first parameter related to a first position associated with the first commodity of the reward function is fixed; and
outputting information representing a relationship between the first commodity and a second commodity based on a second parameter related to a second position associated with the second commodity, the second parameter being included in the second one or more parameters.

6. The computer-implemented method according to claim 5, wherein
the modifying includes modifying the first one or more parameters of the reward function to the second one or more parameters by the inverse reinforcement learning based on the movement paths of the plurality of customers under a state where the first parameter is set to be a given value or more, and
the outputting includes outputting the information based on a result of comparing the second parameter included in the updated reward function with a threshold.

7. The computer-implemented method according to claim 6, wherein
the outputting includes, when the second parameter included in the updated reward function is equal to or more than the threshold, outputting the information representing that the first commodity and the second commodity have a purchase correlation with each other.

8. The computer-implemented method according to claim 5, wherein
the plurality of customers have an attribute among customers that have purchased the first commodity.

9. An information processing apparatus comprising:
a memory; and
a processor coupled to the memory, the processor being configured to
perform obtainment of movement paths included in a plurality of customers that have purchased a first commodity,
perform modification of first one or more parameters of a reward function to second one or more parameters, the reward function including a state of a plurality of positions respectively associated with a plurality of commodities including the first commodity, by inverse reinforcement learning based on the movement paths of the plurality of customers under a state where a first parameter related to a first position associated with the first commodity of the reward function is fixed, and
perform output of information representing a relationship between the first commodity and a second commodity based on a second parameter related to a second position associated with the second commodity, the second parameter being included in the second one or more parameters.

10. The information processing apparatus according to claim 9, wherein
the modification includes modifying the first one or more parameters of the reward function to the second one or more parameters by the inverse reinforcement learning based on the movement paths of the plurality of customers under a state where the first parameter is set to be a given value or more, and
the output includes outputting the information based on a result of comparing the second parameter included in the updated reward function with a threshold.

11. The information processing apparatus according to claim 10, wherein
the output includes, when the second parameter included in the updated reward function is equal to or more than the threshold, outputting the information representing that the first commodity and the second commodity have a purchase correlation with each other.

12. The information processing apparatus according to claim 9, wherein
the plurality of customers have an attribute among customers that have purchased the first commodity.
